(19) United States
(12) Patent Application Publication
(10) Pub. No.: US 2025/0128362 A1
(43) Pub. Date: Apr. 24, 2025

(54) MICROMETER METAL PARTICLE REINFORCED TIN-BISMUTH LOW TEMPERATURE SOLDER MATERIALS

(71) Applicant: Intel Corporation, Santa Clara, CA (US)

(72) Inventors: Rui Zhang, Chandler, AZ (US); Jiaqi Wu, Chandler, AZ (US); Brian Franco, Portland, OR (US); Xiao Lu, Chandler, AZ (US); Mukul Renavikar, North Plains, OR (US)

(73) Assignee: Intel Corporation, Santa Clara, CA (US)

(21) Appl. No.: 18/492,371

(22) Filed: Oct. 23, 2023

(51) Int. Cl. B23K 35/26; B23K 35/02; B23K 103/08; C22C 13/02

(52) U.S. Cl. CPC B23K 35/262; B23K 35/0244; C22C 13/02; B23K 2103/08

(57) ABSTRACT

Solder materials and microelectronic devices and systems deploying the solder materials are discussed. The solder material includes a bulk material of tin and bismuth and particles interspersed in the tin and bismuth bulk material. The particles are a metal other than tin and bismuth, and an intermetallic compound is formed around the particles. The intermetallic compound includes the metal of the particles and tin or bismuth. The solder materials are deployed as interconnect structures to interconnect components, such as electrically coupling an integrated circuit package to a motherboard.

### BACKGROUND

The electronics industry is continually striving to produce ever faster, more efficient, and more powerful computing products. With the advancement of artificial intelligence (AI), internet of things (IoT), cloud computing, telecommunication, and other technologies, the demand for high-performance computing (HPC) products is on the rise. Heterogeneous integration is one technology that is being deployed to address these increasing product demands. In heterogeneous integration, the die complex area per package is, in turn, increasing from about 1,600 mm² to 4,800-6,400 mm² or more. As a result, the package form factor increases, which results in higher warpage during the surface mount technology (SMT) process that attaches the package to a microelectronics board such as a motherboard. For 1 mm pitch ball gride array (BGA) packages, current solders such as tin-silver-copper (SAC) solders have high failure rates at about 2,000 mm² die complex areas. For increasing die complex and corresponding package area sizes, reducing the reflow peak temperature with low temperature solder (LTS) is a promising approach. However, current LTS materials have drawbacks including reduced current carrying capability, reliability problems, and others. It is with respect to these and other considerations that the present improvements have been needed. Such improvements may become critical as the desire to improve computing device performance becomes even more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 illustrates a cross-sectional side view of an integrated circuit assembly including a solder interconnect having metal reinforcement particles within a tin-bismuth bulk solder material electrically coupling metallization structures;

FIG. 2 is a flow diagram illustrating an example process for fabricating a solder ball including metal reinforcement particles within a tin-bismuth bulk solder material;

FIGS. 3, 4, and 5 are illustrations of materials and workpieces as the operations of the process of FIG. 2 are performed to fabricate a solder ball including metal reinforcement particles within a tin-bismuth bulk solder material;

FIG. 6 is a flow diagram illustrating an example process for assembling a system including a solder interconnect having metal reinforcement particles within a tin-bismuth bulk solder material;

FIGS. 7, 8, 9, and 10 cross-sectional side views of integrated circuit device structures as the operations of the process of FIG. 6 are performed to assemble a device or system including a solder interconnect having metal reinforcement particles within a tin-bismuth bulk solder material;

FIG. 11 is a cross-sectional top-down view of the integrated circuit device structure of FIG. 10 showing an exemplary integrated circuit die layout;

FIG. 12 is a cross-sectional top-down view of the integrated circuit device structure of FIG. 10 showing an exemplary solder interconnect layout;

FIG. 13 is a cross-sectional side view of the integrated circuit device structure of FIG. 10 after incorporation into a system;

FIG. 14 illustrates exemplary systems employing an assembly including a solder interconnect having metal reinforcement particles within a tin-bismuth bulk solder material; and

FIG. 15 is a functional block diagram of an electronic computing device, all in accordance with some embodiments.

### DETAILED DESCRIPTION

One or more embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that the present invention may be practiced without these specific details. In some instances, well-known methods and devices are shown in block diagram form, rather than in detail, to avoid obscuring the present invention. Reference throughout this specification to “an embodiment” or “one embodiment” means that a particular feature, structure, function, or characteristic described in connection with the embodiment is included in at least one embodiment of the invention. Thus, the appearances of the phrase “in an embodiment” or “in one embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. Herein, the term “predominantly” indicates not less than 50% of a particular material or component while the term “substantially pure” indicates not less than 99% of the particular material or component and the term “pure” indicates not less than 99.9% of the particular material or component. Unless otherwise indicated, such material percentages are based on atomic percentage. Herein the term concentration is used interchangeably with material percentage and also indicates atomic percentage unless otherwise indicated.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” “on”, and/or the like, as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening features. The term immediately adjacent indicates such features are in direct contact. Furthermore, the terms “substantially,” “close,” “approximately,” “near,” and “about,” generally refer to being within +/−10% of a target value. The term layer as used herein may include a single material or multiple materials. As used in throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. The terms “lateral”, “laterally adjacent” and similar terms indicate two or more components are aligned along a plane orthogonal to a vertical direction of an overall structure.

As used herein, the terms “monolithic”, “monolithically integrated”, and similar terms indicate the components of the monolithic overall structure form an indivisible whole not reasonably capable of being separated. The term “package” generally refers to a self-contained carrier of one or more dice, where the dice are attached to the package substrate, and may be encapsulated for protection, with integrated or wire-boned interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

Here, the term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials. Here, the term “coreless” generally refers to a substrate of an integrated circuit package having no core. The lack of a core allows for higher-density package architectures. as the through-vias have relatively large dimensions and pitch compared to high-density interconnects.

Here, the term “dielectric” generally refers to any number of non-electrically conductive materials that make up the structure of a package substrate. For purposes of this disclosure, dielectric material may be incorporated into an integrated circuit package as layers of laminate film or as a resin molded over integrated circuit dice mounted on the substrate. Here, the term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric. Here, the term “bond pad” generally refers to metallization structures that terminate integrated traces and vias in integrated circuit packages and dies. The term “solder pad” may be occasionally substituted for “bond pad” and carries the same meaning. Here, the term “solder bump” generally refers to a solder layer formed on a bond pad. The solder layer typically has a round shape, hence the term “solder bump”. Here, the term “substrate” generally refers to a planar platform comprising dielectric and metallization structures. The substrate mechanically supports and electrically couples one or more IC dies on a single platform, with encapsulation of the one or more IC dies by a moldable dielectric material. The substrate generally comprises solder bumps as bonding interconnects on both sides. One side of the substrate, generally referred to as the “die side”, comprises solder bumps for chip or die bonding. The opposite side of the substrate, generally referred to as the “land side”, comprises solder bumps for bonding the package to a printed circuit board.

Solder materials, apparatuses, microelectronic assemblies, systems, and techniques are described herein related to low temperature solders including metal particles, such as copper or nickel particles, interspersed in a tin-bismuth bulk material.

As discussed, as die complex and package areas increase, there is a corresponding higher warpage during the surface mount technology (SMT) process that attaches the package to a microelectronics board such as a motherboard. This causes attachment failures, broken connections, and other problems. Currently, there are a number of approaches to mitigate or resolve this issue including increasing the substrate core thickness, changing the substrate core material to a stiffer material, or increasing the thickness of the stiffener and/or lid used in the package. However, such changes are expensive and disruptive while the high temperature warpage reduction may not be significant enough for future size increases. Furthermore, increasing the overall system Z height is undesirable. Alternatively, multiple tin-silver-copper (SAC) solders ball sizes may be used on the same package to counter the high temperature warpage shape (e.g., using larger balls on locations where open risk is high and smaller balls on locations where bridging risk is high). However, such approaches are difficult to deploy in multiple different applications, and the need for very accurate ball sizes can lead to failures. Other difficulties arise such as manufacturing complexity and the inability for the different ball sizes to accommodate the warpage in some applications.

Reducing the reflow peak temperature with low temperature solder (LTS) materials is a promising approach to eliminate or mitigate warpage problems in SMT processing. For example, current SAC solders reflow at a temperature of about 240° C. By reducing the reflow temperature to about 190° C. or less, the warpage is reduced to a point where large area die complexes/packages can be readily attached without warpage concerns. For example, die complex areas of greater than 1,600 mm², such as those of 4,800 to 6,400 mm² or more, can be reliably attached without warpage problems at reflow temperatures of about 190° C. However, current low temperature solders such as tin-bismuth solders have limitations. While tin-bismuth alloys are compatible with low temperature SMT processing, in use, the bismuth element migrates along the electron flow direction, which results in bismuth segregation on the anode side. As a result, the resistance of the solder interconnect increases, and the mechanical integrity of the joint can be compromised due to the high resistivity and brittleness of bismuth. For example, tin-bismuth (i.e., Sn—Bi) based solders have reduced current carrying capability and mechanical problems compared to SAC. This limits its deployment in, for example, high-performance computing (HPC) products which require the solder interconnects (e.g., BGA interconnects) to carry high current.

The techniques and structures discussed herein provide a tin-bismuth low temperature solder material reinforced with micrometer metal particles such as copper or nickel particles. The solder materials discussed herein advantageously have the same ball attach (BA) and SMT capabilities as current tin-bismuth ball grid array (BGA) materials, while significantly improving the current carrying capability of the solder interconnects. For example, micrometer copper or nickel particle reinforced tin-bismuth low temperature solder materials are disclosed that improve, for example, electromigration/maximum current performance. Such improvements, in turn, enable products deploying ultra-large form factor high power BGA packages.

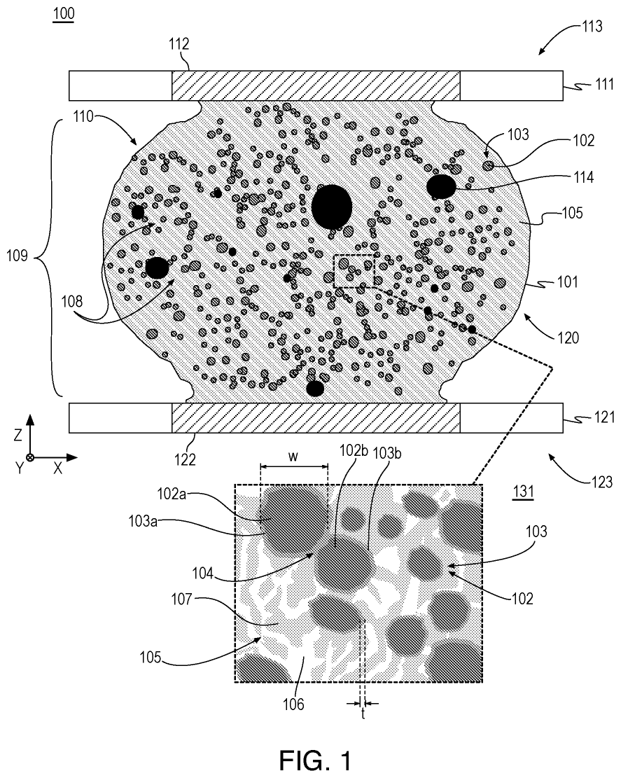

FIG. 1 illustrates a cross-sectional side view of an integrated circuit assembly 100 including a solder interconnect structure 110 having metal reinforcement particles within a tin-bismuth bulk solder material electrically coupling metallization structures 112, 122, arranged in accordance with some embodiments. As shown, solder interconnect structure 110 extends between and contacts each of metallization structure 112 and metallization structure 122. Metallization structure 112 may be embedded within a dielectric material 111, and metallization structure 112 and dielectric material 111 may be part of an integrated circuit (IC) device 113, such as an IC package. Metallization structure 122 may be embedded within a dielectric material 121, and metallization structure 122 and dielectric material 121 may be part of a host component 123, such as microelectronics board. In some embodiments, solder interconnect structure 110 includes voids 114.

Solder interconnect structure 110 may be shaped as a solder ball 101, and solder interconnect structure 110 is a solder material 120 including a bulk material 105 and metal particles 102 interspersed in bulk material 105. Although illustrated as a solder ball 101, which may be part of a ball grid array (BGA), solder interconnect structure 110 may have any suitable form factor. In some embodiments, solder interconnect structure 110 has a lateral width (i.e., a maximum cross-sectional dimension in the x-y plane) of between about 200 to 400 microns. In some embodiments, the lateral width is a diameter of solder ball 101. In some embodiments, solder interconnect structure 110 has a vertical height (i.e., a dimension in the z-direction) of between about 150 to 300 microns. The vertical height of solder interconnect structure 110 may also define the vertical offset between IC device 113 and host component 123. Other sizes and aspect ratios may be used for solder interconnect structure 110.

As shown, solder interconnect structure 110 includes metal particles 102 interspersed in bulk material 105. As used herein, the term interspersed is used in its common usage to indicate metal particles 102 are scattered throughout bulk material 105 but are not necessarily in any pattern. Bulk material 105 includes tin and bismuth. As discussed, solders including tin and bismuth have a relatively low reflow temperature so IC device 113 and/or host component 123 do not have warpage problems when IC device 113 is attached to host component 123. For example, at the reflow temperature of solder interconnect structure 110, which is about 190° C. or less, dielectric material 111 and/or dielectric material 121 may not warp to an extent that they may not be reliably bonded together in a SMT process that bonds IC device 113 and host component 123. In some embodiments, bulk material 105 is a eutectic compound of tin and bismuth. As used herein, the term eutectic compound indicates a compound or mixture of constituent elements having a lower melting point than that of the constituent elements. In eutectic compounds or mixtures, the solidus and liquidus temperatures are the same. In some embodiments, bulk material 105 is an off-eutectic compound of tin and bismuth. As used herein, the term off-eutectic compound indicates a compound or mixture of constituent elements where the solidus and liquidus temperatures are different.

One or more of metal particles 102, some of metal particles 102, or all of metal particles 102, are surrounded by intermetallic compound 103, which is illustrated in enlarged view 131. In enlarged view 131, metal particles 102 are illustrated as dark gray, intermetallic compound 103 is illustrated as a medium gray (and intermetallic compound 103 surrounds metal particles 102), tin regions 107 of bulk material 105 are illustrated as light gray, and bismuth regions 106 of bulk material 105 are illustrated as white. Metal particles 102 may include any suitable metal that is other than tin and bismuth and that forms intermetallic compound 103 with one of tin and bismuth. As used herein, the term intermetallic compound indicates a metal alloy having an ordered solid-state structure. In some embodiments, an intermetallic compound has a particular stoichiometry of the alloyed materials. In some embodiments, the solid-state structure is a crystalline structure such that at least a portion of intermetallic compound 103 is crystalline. In some embodiments, intermetallic compound 103 is polycrystalline. The metal alloy of intermetallic compound 103 is an alloy of one of tin and bismuth and the metal of metal particles 102.

As shown in the context of enlarged view 131, metal particles 102 are substantially pure (i.e., not less than 99%) or pure (i.e., indicates not less than 99.9%) metal. Intermetallic compound 103 surrounds metal particles 102 and, as discussed, is an ordered solid-state structure of the metal of metal particles 102 and one of tin and bismuth. In some embodiments, the metal of metal particles 102 is advantageously alloyed with tin to form intermetallic compound 103. Such materials may provide a greater limit on bismuth electromigration. However, alloys of bismuth and the metal of metal particles 102 also advantageously reduces bismuth electromigration. The metal of metal particles 102 may be any suitable metal including any of aluminum, scandium, titanium, vanadium, chromium, manganese, iron, cobalt, nickel, copper, zinc, gallium, germanium rubidium, strontium, yttrium, zirconium, niobium, molybdenum, ruthenium, rhodium, palladium, silver, cadmium, indium, antimony, cesium, barium, hafnium, tantalum, tungsten, iridium, platinum, or gold.

For example, solder interconnect structure 110 is formed of solder material 120 that includes bulk material 105, which includes tin and bismuth, metal particles 102 interspersed in bulk material 105, such that metal particles 102 are a metal other than tin and bismuth, and intermetallic compound 103 immediately adjacent metal particles 102, such that intermetallic compound 103 includes the metal of metal particles 102 and one of tin or bismuth.

In some embodiments, metal particles 102 are substantially pure or pure copper. In such contexts, intermetallic compound 103 may be an alloy of copper and one of tin and bismuth. In some embodiments, intermetallic compound 103 is an alloy of copper and tin. In some embodiments, intermetallic compound 103 is or includes Cu₆Sn₅. In some embodiments, intermetallic compound 103 is an alloy of copper and bismuth. In some embodiments, metal particles 102 are substantially pure or pure nickel. In such contexts, intermetallic compound 103 may be an alloy of nickel and one of tin and bismuth. In some embodiments, intermetallic compound 103 is an alloy of nickel and tin. In some embodiments, intermetallic compound 103 is or includes Ni₆Sn₅. In some embodiments, intermetallic compound 103 is an alloy of nickel and bismuth. In some embodiments, metal particles 102 are substantially pure or pure silver. In such contexts, intermetallic compound 103 may be an alloy of silver and one of tin and bismuth.

In some embodiments, intermetallic compound 103 is an alloy of silver and tin. In some embodiments, intermetallic compound 103 is or includes Ag₃Sn. In some embodiments, intermetallic compound 103 is an alloy of silver and bismuth. Notably, copper, nickel, and silver offer advantages when deployed as metal particles 102 inclusive of workability, the ability to reliably form intermetallic compound 103, and intermetallic compounds 103 (e.g., including nickel or copper) substantially mitigating electromigration of bismuth in solder material 120.

As shown in enlarged view 131, metal particles 102 have a cross-sectional width w, which may be a largest cross-sectional dimension (i.e., edge-to-edge) that extends through a centroid of metal particles 102. In some embodiments, cross-sectional width w of metal particles 102 is in the micrometer range such that metal particles 102 have a cross-sectional width w in the range of about 1 to 20 microns. In some embodiments, cross-sectional width w is in the range of 1 to 15 microns. In some embodiments, cross-sectional width w is in the range of 1 to 8 microns. The cross-sectional width of a sample of metal particles 102 may be an average of the cross-sectional widths of metal particles 102, a median of the cross-sectional widths of metal particles 102, or the like.

Metal particles 102 and surrounding intermetallic compound 103 form a network 108 of metal particles 102 and intermetallic compound 103 that extends throughout solder interconnect structure 110. For example, network 108 extends throughout solder interconnect structure 110 in all dimensions including the vertical or z-direction such that network 108 provides a vertical network 109 through solder interconnect structure 110 to prevent electromigration of bismuth in the vertical or z-direction (i.e., in the direction of current flow through solder interconnect structure 110). As used herein, the term network of metal particles 102 or network of intermetallic compound 103 indicates a material structure where, although not in physical contact throughout solder interconnect structure 110, the structures or features of the network are within a proximity of one another to influence the bulk material properties of solder interconnect structure 110. In some embodiments, the structures or features are not more than 20 microns separated from one another. The separation may be measured as an average separation in a particular sample, as a maximum separation in the sample, or the like. In some embodiments, the separation is not more than 10 microns. In some embodiments, the separation is in the range of 10 to 30 microns. Other network sizes may be used. Notably, network 108 of solder material 120 advantageously reduces electromigration of bismuth in solder material 120 while solder interconnect structure 110 is in use.

With reference to enlarged view 131, in some contexts, intermetallic compound 103 extends between metal particles 102, as shown with respect to portion of intermetallic compound 104. Notably, portion of intermetallic compound 104 is in contact with metal particle 102a and metal particle 102b. Furthermore, metal particle 102a is surrounded by intermetallic compound 103a and metal particle 102b is surrounded by intermetallic compound 103b. Portion of intermetallic compound 104 may be a part of either or both of intermetallic compound 103a and intermetallic compound 103b. Also as shown, intermetallic compound 103 may extend from an edge of metal particles 102 by a distance or thickness t. In some embodiments, thickness t is in the range of 20 nm to 500 nm. In some embodiments, thickness t is in the range of 40 nm to 200 nm. In some embodiments, thickness t is in the range of 25 nm to 100 nm. Other thicknesses may be used.

Although illustrated with respect to a single type of metal particles 102 being deployed in solder material 120, in some embodiments, solder material 120 may include more than a single type of metal particles 102. For example, solder material 120 may include two, three, or more types of metal particles 102, and corresponding intermetallic compounds. In some embodiments, solder material 120 includes second particles (i.e., in addition to metal particles 102) interspersed in bulk material 105 such that the second particles are a second metal other than tin or bismuth and different than the metal of metal particles 102. In such contexts, a second intermetallic compound is immediately adjacent the second particles (i.e., in analogy to intermetallic compound 103) such that second intermetallic compound includes the second metal of the second particles and one of tin or bismuth. The second metal particles and second intermetallic compound may be any materials and may have any characteristics discussed with respect to metal particles 102 and intermetallic compound 103. In some embodiments, the metal of metal particles 102 is copper, the second metal of the second metal particles is nickel, intermetallic compound 103 includes tin and copper (e.g., intermetallic compound 103 is Cu₆Sn₅), and the second intermetallic compound includes tin and nickel (e.g., the second intermetallic compound is Ni₆Sn₅). Other combinations of the materials discussed herein may be used.

With continued reference to FIG. 1, including enlarged view 131, solder material 120 of solder interconnect structure 110 includes bulk material 105, which may be a tin-bismuth (i.e., SnBi) low temperature solder (LTS) continuous phase. Bulk material 105 includes bismuth regions 106 and tin regions 107 that do not substantially mix. Instead, bismuth regions 106 and tin regions 107 are substantially separated by boundaries therebetween. For example, bulk material 105 may be a scrambled mix of bismuth regions 106 and tin regions 107, as illustrated. Bulk material 105 may include any suitable fractions of tin and bismuth. In some embodiments, bulk material 105 is 50 to 70 wt % tin and a balance of bismuth. Other suitable fractions of tin and bismuth may be used. Solder material 120 of solder interconnect structure 110 further includes metal particles 102 (e.g., micrometer particles) as reinforcing elements. Metal particles 102 are interspersed in bulk material 105 and may be, for example, substantially uniformly distributed inside the SnBi LTS continuous phase of bulk material 105.

Metal particles 102 may have any particle size, particle size distributions, and particle concentration (i.e., volume fraction within bulk material 105). As discussed, in some embodiments, metal particles 102 may have a cross-sectional width w in the range of 1 to 20 microns, in the range of 1 to 15 microns, in the range of 1 to 8 microns, or the like. In some embodiments, metal particles 102 have a particle size distribution such that the particle size ranges within those exemplary ranges and is centered at about the midpoint of the exemplary ranges. In some embodiments, metal particles 102 have a target size that is within the discussed range and then a distribution of particle sizes around the target size. For example, the sizes of metal particles may be within ±2, ±3, or ±5 microns of a target cross-sectional width. Metal particles 102 may have any suitable particle size distribution such as a substantially Gaussian distribution. Other particle size distributions may be used. The particle concentration of metal particles 102 within bulk material 105 may also be any suitable value. In some embodiments, a volume fraction of metal particles 102 within bulk material 105 (i.e., the volume of metal particles 102 within a sample volume divided by the volume of the sample volume) is in the range of 3% to 30%. In some embodiments, the volume fraction of metal particles 102 is in the range of 5% to 20%. In some embodiments, the volume fraction of metal particles 102 is in the range of 10% to 15%. Other volume fractions may be used.

In some embodiments, the micrometer particles size of metal particles 102, the particle size distributions of metal particles 102, and the particle concentration of metal particles 102 are designed and controlled such that solder material 120 maintains substantially the same ball attach and surface mount assembly properties as a SnBi LTS solder matrix absent metal particles 102. As discussed, solder material 120 includes a continuous and interconnected micrometer particle network such as network 108 that forms inside the SnBi LTS solder matrix of bulk material 105. The interconnected micrometer particle IMC network acts as a barrier to effectively slow down the bismuth migration and segregation process for improved electromigration and maximum current (Imax) performance. Thereby, solder material 120 resolves the electromigration problems discussed above, and does not impact package architecture such that solder interconnect structure 110 (e.g., a BGA joint) has high performance current carrying capability for high performance computing products. Notably, solder material 120 enables large form factor BGA attachment for IC packages having large die complexes.

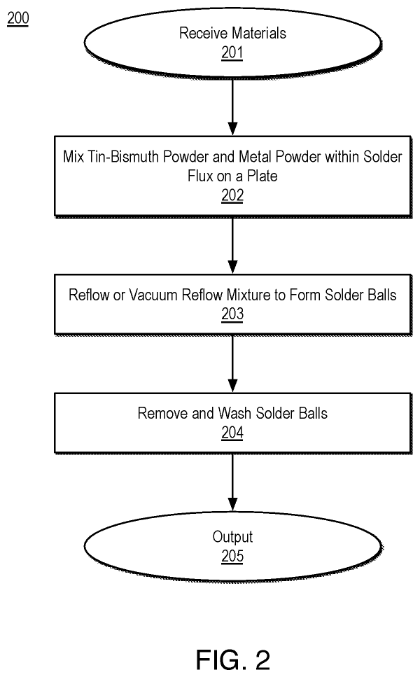

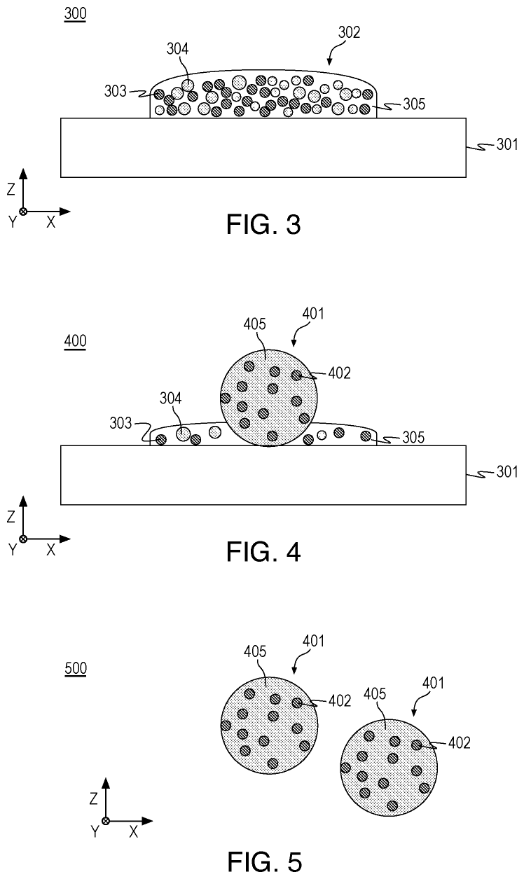

FIG. 2 is a flow diagram illustrating an example process 200 for fabricating a solder ball including metal reinforcement particles within a tin-bismuth bulk solder material, arranged in accordance with some embodiments. FIGS. 3, 4, and 5 are illustrations of materials and workpieces as the operations of process 200 are performed to fabricate a solder ball including metal reinforcement particles within a tin-bismuth bulk solder material, arranged in accordance with some embodiments, arranged in accordance with some embodiments.

As shown, process 200 begins at operation 201, where the materials are received for processing. In some embodiments, a first powder or tin and bismuth particles and a second powder of the reinforcement metal, as well as a solder flux are received for processing. The first and second powders may include particles of any size such as those discussed with respect to metal particles 102. The solder flux may be any suitable material to aid in the formation of solder balls, such as water-soluble paste.

Processing continues at operation 202, where the tin-bismuth powder and the reinforcement powder are mixed with the flux on a plate in preparation for reflow. The tin-bismuth powder, the reinforcement metal powder, and the flux may be mixed and deposited on the plate using any suitable technique or techniques such as auger mixing and deposition techniques. In some embodiments, the reinforcement metal micrometer particles are first mixed with tin-bismuth solder particles. Then, the particle mixture (e.g., the mixed powder system) is mixed again with the flux system. The plate may advantageously be an alumina ceramic plate, in some embodiments.

FIG. 3 illustrates materials and workpieces 300 including a mixture 302 prepared for solder ball fabrication. As shown, mixture 302 includes metal particles 303 of a metal other than tin and bismuth, tin-bismuth particles 304, and flux 305. For example, metal particles 303 may have any characteristics discussed with respect to metal particles 102. Tin-bismuth particles 304 may have any suitable characteristics for the formation of bulk material 105. In some embodiments, metal particles 303 are substantially pure or pure aluminum, scandium, titanium, vanadium, chromium, manganese, iron, cobalt, nickel, copper, zinc, gallium, germanium, rubidium, strontium, yttrium, zirconium, niobium, molybdenum, ruthenium, rhodium, palladium, silver, cadmium, indium, antimony, cesium, barium, hafnium, tantalum, tungsten, iridium, platinum, or gold. In some embodiments, metal particles 303 are substantially pure or pure copper. In some embodiments, metal particles 303 are substantially pure or pure nickel. In some embodiments, metal particles 303 are substantially pure or pure silver. As discussed, deployment of copper, nickel, or silver offer advantages of workability and reliability in some contexts. Although illustrated with a single type of metal particles 303, more than one metal powder may be deployed. For example, first particles of substantially pure or pure copper and second particles of substantially pure or pure nickel may be used. Mixture 302 is formed on a plate 301, which may be an alumina ceramic plate (e.g., Al₂O₃ ceramic) in some embodiments.

Returning to FIG. 2, processing continues at operation 203, where the mixture formed at operation 202 is reflowed or vacuum reflowed to form solder balls. The reflow or vacuum reflow processing may use any suitable technique or techniques. In some embodiments, the solder paste or mixture formed at operation 202 is subjected to a controlled heat to bring it to a molten state, where surface tension forms a solder ball. In some embodiments, the reinforcement metal powder does not melt during such processing. For example, the reinforcement metal may have a very high melting point relative to the tin-bismuth material. In some embodiments, vacuum reflow processing is deployed, which includes pulling a vacuum during the heat cycle. Such processing may remove voids and improve solder ball fabrication reliability.

FIG. 4 illustrates materials and workpieces 400 similar to materials and workpieces 300 after reflow or vacuum reflow processing formation of a solder ball 401. Solder ball 401 may have any characteristics discussed herein with respect to solder material 120. As shown, solder ball includes metal particles 402 (e.g., some of metal particles 303) interspersed in a bulk material 405. Bulk material 405 is formed from tin-bismuth particles 304, and bulk material 405 may have any characteristics discussed with respect to bulk material 105. In some embodiments, the tin-bismuth powder and flux are heated to a temperature that brings those materials to a molten state to form bulk material 405 while the metal particles 303 are not brought to a molten state. As shown in FIG. 4, solder balls 401 may be sphered out from mixture 302 (e.g., the solder paste material formed at operation 202.

Returning to FIG. 2, processing continues at operation 204, where the solder balls formed at operation 203 are removed and washed, and at operation 205 where the solder balls are output for further processing, such as surface mount attachment of an IC device to a microelectronics board, for example. The solder balls may be removed using any suitable technique or techniques such as pick and place operations and the solder balls may be cleaned using any suitable technique or techniques such as deflux operations or the like.

FIG. 5 illustrates materials and workpieces 500 similar to materials and workpieces 400 after removal and clean of solder balls 401. As discussed, solder balls 401 may be removed using any suitable technique or techniques such as pick and place operations, and solder balls 401 may be cleaned and output in preparation for surface mount processing.

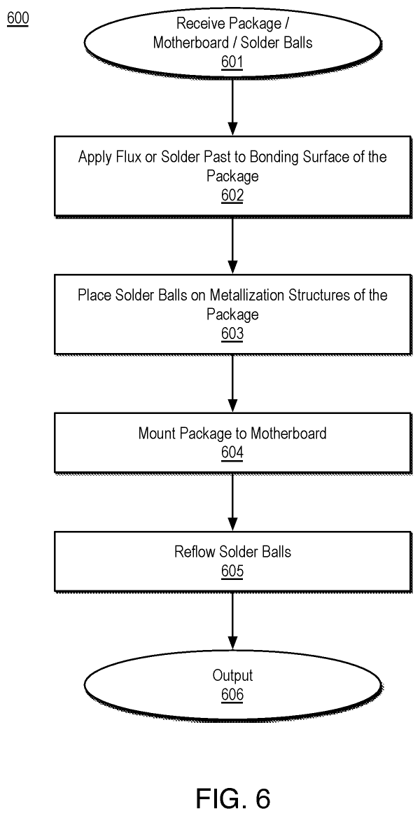

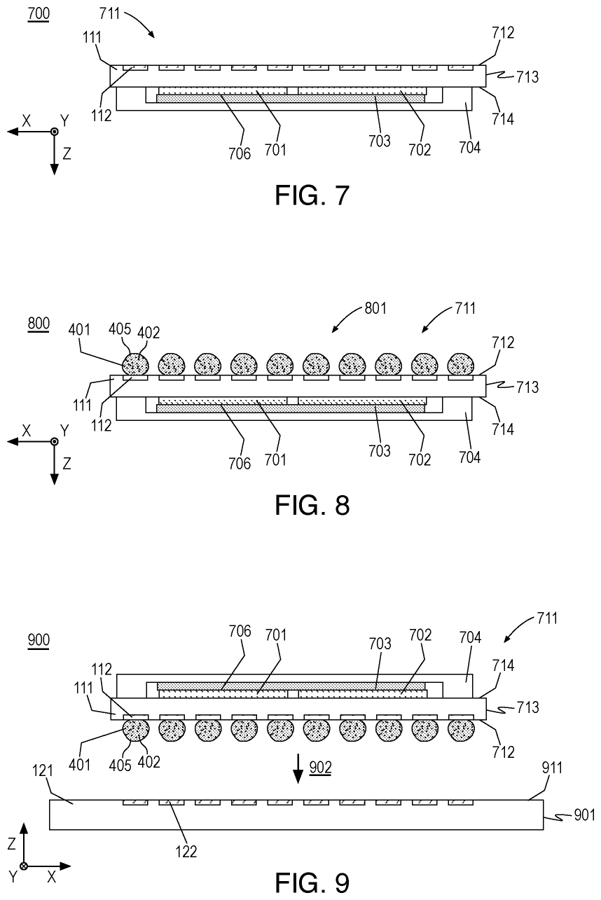

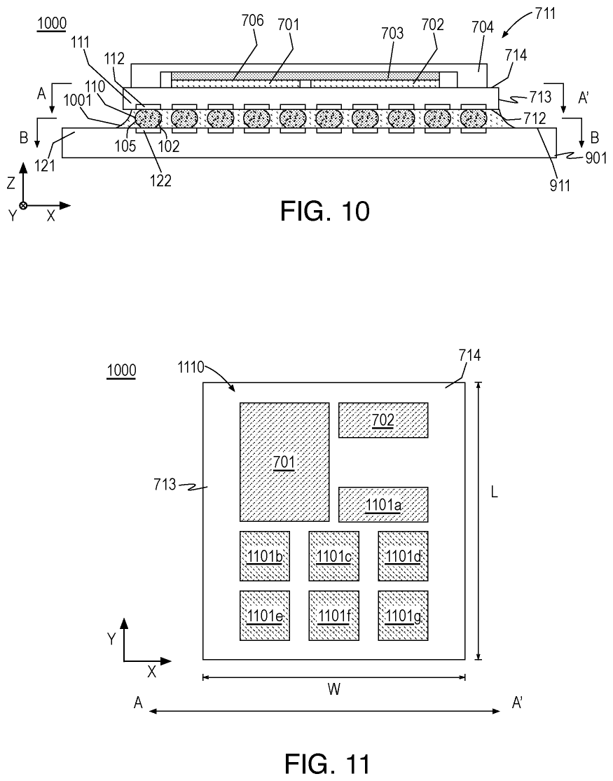

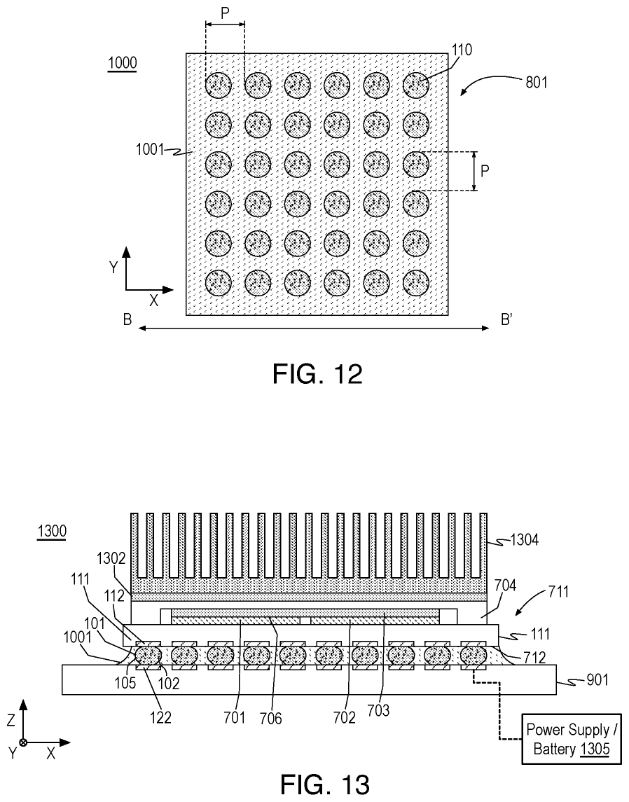

FIG. 6 is a flow diagram illustrating an example process 600 for assembling a device or system including a solder interconnect having metal reinforcement particles within a tin-bismuth bulk solder material, arranged in accordance with some embodiments. FIGS. 7, 8, 9, and 10 cross-sectional side views of integrated circuit device structures as the operations of process 600 are performed to assemble a device or system including a solder interconnect having metal reinforcement particles within a tin-bismuth bulk solder material, arranged in accordance with some embodiments. FIG. 11 is a cross-sectional top-down view of the integrated circuit device structure of FIG. 10 showing an exemplary integrated circuit die layout, arranged in accordance with some embodiments. FIG. 12 is a cross-sectional top-down view of the integrated circuit device structure of FIG. 10 showing an exemplary solder interconnect layout, arranged in accordance with some embodiments. FIG. 13 is a cross-sectional side view of the integrated circuit device structure of FIG. 10 after incorporation into a system, arranged in accordance with some embodiments.

As shown, process 600 begins at operation 601, where workpieces, such as an IC package, a motherboard, and solder balls are received for processing. The microelectronics board, although illustrated with respect to a motherboard may be any suitable microelectronics board, substrate, or the like. The microelectronics board may be preprocessed to form exposed metallization structures (e.g., metal bond pads) embedded in a dielectric layer for subsequent bonding. Furthermore, the IC package may be any suitable form factor and the IC package may also be preprocessed to form exposed metallization structures (e.g., metal bond pads) embedded in a dielectric layer for subsequent bonding. The solder balls may be any suitable solder balls having metal reinforcement particles within a tin-bismuth bulk solder material, such as solder balls 401.

FIG. 7 illustrates an example integrated circuit device structure 700 including an IC package 711 to be bonded to a microelectronics substrate. IC package may be characterized as an IC device, an IC system, a surface mountable device or system, or the like. For example, IC package 711 and IC device 113 may share any characteristics. As shown, IC package 711 includes any number IC dies 701, 702 mounted to and electrically coupled to a substrate 713. Substrate 713 may be any suitable substrate such as an interposer, a printed circuit board, or the like. As shown, substrate 713 includes metallization structures 112 embedded in dielectric material 111. One or more IC dies 701, 702 are attached to a first surface 714 of substrate 713 by a number of interconnects (not shown) therebetween, which may be characterized as IC die level interconnects. Additional metal routing may extend through substrate 713 to connect the IC die level interconnects to metallization structures 112, which may be characterized as package level interconnects. For example, metallization structures 112 may be copper bond pads. Substrate 713 also includes a second surface 712 to be bonded to a microelectronics board. IC dies 701, 702 may be any appropriate devices, including, but not limited to, a microprocessor, a die complex, a multichip complex, a chipset, a graphics device, a wireless device, a memory device, an application specific integrated circuit device, artificial intelligence compute devices, cloud computing devices, telecommunication devices, combinations thereof, stacks thereof, or the like.

Integrated circuit device structure 700 further includes a thermal interface material (TIM) 703 disposed on a surface 706 of IC dies 701, 702. TIM 703 may include any suitable thermal interface material and may be characterized as TIM 1. An integrated heat spreader 704, having a surface on TIM 703 extends over IC dies 701, 702, and is mounted to substrate 713. Integrated heat spreader 704 may include a planar structure (e.g., in the x-y plane) having a surface on TIM 703 and extensions projecting from the surface of the planar structure into contact with substrate 713. Integrated heat spreader 704 may be any appropriate thermally conductive material, including, but not limited to copper, aluminum, nickel, alloys thereof, and the like. Although illustrated with respect to integrated circuit device structure 700 having TIM 703 and integrated heat spreader 704 during bonding, such materials and structures may be formed and attached after surface mount of IC package 711 to a microelectronics board.

Returning to FIG. 6, processing continues at operation 602, where flux or solder paste is optionally applied to the bonding surface of the package, and at operation 603, where the solder balls having metal reinforcement particles within a tin-bismuth bulk solder material, such as solder balls 401, are placed on the bonding surface of the package. The flux or solder paste may be applied using any suitable technique or techniques and may clean the surface of the package substrate and promote adhesion. The solder balls having metal reinforcement particles within a tin-bismuth bulk solder material may be placed on the package substrate using any suitable technique or techniques such as automated placement techniques. In some embodiments, the flux holds the solder balls in place for continued processing. In some embodiments, the solder balls may be heat treated or reflowed to bond to the underlying metallization structures.

FIG. 8 illustrates an example integrated circuit device structure 800 similar to integrated circuit device structure 700 after placement of solder balls 401 on metallization structures 112. As discussed, solder balls 401 may be placed on metallization structures 112 using any suitable technique or techniques. In some embodiments, solder balls 401 are placed after application of a flux material (not shown). Each of solder balls 401 includes metal particles 402 interspersed in bulk material 405. In some embodiments, solder balls 401 are in a grid pattern 801 (e.g., a ball grid array), as illustrated herein below in FIG. 12. As shown in FIG. 8, solder balls 401 are attached to second surface 712 (e.g., a land side) of IC package 711 using any suitable solder ball attach process. Notably, the overall ball attach performance of solder balls 401 (e.g., solder balls including metal reinforcement microparticles interspersed in tin-bismuth bulk solder material) is similar to that of fully tin-bismuth solder balls both in terms of melting characteristics and wetting behavior on metallization structures 112 (e.g., on BGA pads).

Returning to FIG. 6, processing continues at operation 604, where the IC package is mounted to a microelectronics board such as a motherboard, and at operation 605 where the solder balls having metal reinforcement particles within a tin-bismuth bulk solder material are reflowed to form solder interconnects having metal reinforcement particles within a tin-bismuth bulk solder material, as discussed herein with respect to FIG. 1. The IC package may be mounted to the microelectronics board using any suitable technique or techniques such as pick and place techniques. The solder balls may be reflowed at any suitable temperature such as a temperature of not more than 190° C. As discussed, such low temperature solder reflow temperatures advantageously do not warp the IC package and/or microelectronics board to the extent that a reliable solder bond cannot be formed therebetween. Processing continues at operation 606, where the surface mounted IC package and microelectronics board are output for continued processing such as inclusion in a high-performance computing product.

FIG. 9 illustrates an example integrated circuit device structure 900 similar to integrated circuit device structure 800 as IC package 711 is being mounted to a microelectronics board 901. For example, microelectronics board 901 and host component 123 may share any characteristics. Microelectronics board 901 may include any number of components (not shown) attached to a first surface 911 thereof. Microelectronics board 901 and substrate 713 may include a number of dielectric material layers that may include build-up films and/or solder resist layers, and may be composed of an appropriate dielectric material, including, but not limited to, bismaleimide triazine resin, fire retardant grade 4 material, polyimide material, silica filled epoxy material, glass reinforced epoxy material, and the like, as well as low-k and ultra low-k dielectrics (dielectric constants less than about 3.6), including, but not limited to, carbon doped dielectrics, fluorine doped dielectrics, porous dielectrics, organic polymeric dielectrics, and the like. Conductive routes within microelectronics board 901 and substrate 713 may be a combination of conductive traces and conductive vias extending through the plurality of dielectric material layers. The conductive traces and the conductive vias may be made of any appropriate conductive material, including but not limited to, metals, such as copper, silver, nickel, gold, and aluminum, alloys thereof, and the like. Microelectronics board 901 may be a cored substrate or a coreless substrate. Microelectronics board 901 may be characterized as an electronics substrate.

Placement operation 902 aligns IC package 711 over microelectronics board 901 and places IC package 711 onto microelectronics board 901 such that solder balls 401 come into contact with corresponding ones of metallization structures 122. For example, metallization structures 122 may be BGA bond pads contacted by solder balls 401, which include metal particles 402 interspersed in bulk material 405, which is a tin-bismuth solder.

FIG. 10 illustrates an example integrated circuit device structure 1000 similar to integrated circuit device structure 900 after reflow of solder balls 401 to form solder interconnect structures 110 and after application of underfill material 1001. Solder balls 401 may be reflowed to form solder interconnect structures 110 using any suitable technique or techniques. For example, the reflow may be a low temperature solder reflow not exceeding a temperature of 190° C. During reflow, solder balls 401 are heated to a molten state to from an electrical bond to each of metallization structure 112 and metallization structure 122. As shown, after reflow, solder interconnect structures 110 are in contact with and electrically couple metallization structure 112 and metallization structure 122. Solder interconnect structures 110 include metal particles 102 interspersed in bulk material 105, as well as any other features or characteristics discussed herein.

An underfill material 1001, such as an epoxy material, may be disposed between second surface 712 of substrate 713 and first surface 911 of microelectronics board 901, and surrounding solder interconnect structures 110. Underfill material 1001 may be dispensed between first surface 911 of microelectronics board 901 and second surface 712 of substrate 713 as a viscous liquid and then hardened with a curing process. Underfill material 1001 may also be a molded underfill material. Underfill material 1001 may provide structural integrity and may prevent contamination, for example.

FIG. 11 is a cross-sectional top-down view of integrated circuit device structure 1000 taken at plane A-A′. As shown in FIG. 11, IC dies 701, 702 may be a part of an IC die complex 1110 coupled to first surface 714 of substrate 713. As shown, IC die complex 1110 may include any number of IC dies 701, 702, 1101a-g, which may be laterally arrayed on first surface 714 of substrate 713 and/or stacked over first surface 714 of substrate 713. IC dies 701, 702, 1101a-g include any appropriate devices, including, but not limited to, microprocessors, chipsets, graphics devices, wireless device, memory devices, application specific integrated circuit devices, artificial intelligence compute devices, cloud computing devices, telecommunication devices, combinations thereof, stacks thereof, or the like.

Notably, the solder materials and techniques discussed herein provide for attachment of large area (e.g., large form factor) IC packages 711 at low temperature such that difficulties associated with warpage, which occurs at higher reflow temperatures, are avoided. For example, the discussed solder materials and techniques enable substrate 713 to have larger length L and width W dimensions such that the area L×W of substrate 713 is in the range of 4,800-6,400 mm² or more.

FIG. 12 is a cross-sectional top-down view of integrated circuit device structure 1000 taken at plane B-B′. As shown in FIG. 12, solder interconnect structures 110 may be arrayed in grid pattern 801 having a uniform x- and y-dimension pitch P. As used herein, the term pitch indicates a dimension taken between like features. Pitch P may be any suitable value such as 800 to 1,200 microns. In some embodiments, pitch P is about 1 mm. For example, solder interconnect structures 110 may provide a ball grid array (BGA) coupling between metallization structures 112 of IC package 711 and metallization structures 122 of microelectronics board 901.

For example, may be a part of an IC die complex 1110 coupled to first surface 714 of substrate 713. As shown, IC die complex 1110 may include any number of IC dies 701, 702, 1101a-g, which may be laterally arrayed on first surface 714 of substrate 713 and/or stacked over first surface 714 of substrate 713. IC dies 701, 702, 1101a-g include any appropriate devices, including, but not limited to, microprocessors, chipsets, graphics devices, wireless device, memory devices, application specific integrated circuit devices, artificial intelligence compute devices, cloud computing devices, telecommunication devices, combinations thereof, stacks thereof, or the like.

FIG. 13 is a cross-sectional side view of the integrated circuit device structure 1000 after incorporation into a system such as a microelectronic device assembly 1300. As shown, microelectronic device assembly 1300 includes metallization structures 122 of microelectronics board 901 (or host component 123, refer to FIG. 1), metallization structure 112 of IC package 711 (or IC device 113, refer to FIG. 1), and solder interconnect structure 110 coupling metallization structures 122 and metallization structure 112. As discussed, solder interconnect structure 110 includes bulk material 105 that includes tin and bismuth (i.e., a Sn—Bi solder material), metal particles 102 interspersed in bulk material 105 such that the metal of metal particles 102 interspersed in bulk material 105 is other than tin or bismuth, and intermetallic compound 103 (refer to FIG. 1) immediately adjacent one, some, or all of metal particles 102 such that intermetallic compound 103 includes the metal of metal particles 102 and tin or bismuth.

As shown, FIG. 13 is an illustration of microelectronic device assembly 1300 assembly and deployment of heat removal solutions to integrated circuit device structure 1000. Microelectronic device assembly 1300 may deploy any IC structures discussed herein having solder interconnect structures with metal reinforcement particles within a tin-bismuth bulk solder material. Microelectronic device assembly 1300 includes a power supply 1305 coupled to one or both of microelectronics board 901 and IC package 711. Power supply 1305 may include a battery, voltage converter, power supply circuitry, or the like. Microelectronic device assembly 1300 further includes a TIM 1302 disposed on a top surface of integrated heat spreader 704. TIM 1302 may include any suitable thermal interface material and may be characterized as TIM 2, while TIM 703 is characterized as TIM 1. TIM 1302 and TIM 703 may be the same materials, or they may be different. A heat sink 1304 (e.g., an exemplary heat dissipation device or thermal solution) is on TIM 1302 and dissipates heat. Microelectronic device assembly 1300 may be used in desktop and server form factors. In other contexts, a heat solution such as a heat pipe or heat spreader may be mounted directly on TIM 1302. Such assemblies may be used in smaller form factor devices. Other heat dissipation devices may be used.

Embodiments discussed herein include solder interconnects having metal reinforcement particles within a tin-bismuth bulk solder material. Notably, the microparticle reinforced Sn—Bi (e.g., SnBi58) LTS solder ball after ball attach and surface mount attachment may have a solder joint shape similar to that of a fully Sn—Bi solder joint. The microparticles may be distributed relatively uniformed within the entire solder interconnect after ball attach and surface mount reflow. As discussed, the metal reinforcement reduces bismuth electromigration for improved conductivity and structural properties. Notably, the resistance change for microparticle reinforced Sn—Bi is significantly lower than that of fully Sn—Bi solder joints. While not being bound by theory, bismuth tends to segregate and migrate in the same direction as the electron flow. Atom diffusion is more rapid along grain boundaries inside a crystal. As for Sn—Bi systems, phase boundaries between the Sn-rich and Bi-rich phase may be fast diffusion channels for Bi diffusion and migration. In micrometer particle reinformed solders, micrometer particles react to form intermetallic compounds and may form interconnected intermetallic compound networks. Such structures reduce the bismuth diffusion along the disappearing Sn—Bi grain boundaries, and interconnected intermetallic compound networks can act as barriers for bismuth diffusion and migration to improve performance. Furthermore, micrometer particle reinforcement also improves creep resistance of the solder system. This may be due to an increase in the effective volume fraction of the reinforcement phase. The micrometer particle reinforcements intermetallic compound phase may restrain plastic flow/deformation on the solder matrix due to elastic constraints, which may enhance creep resistance.

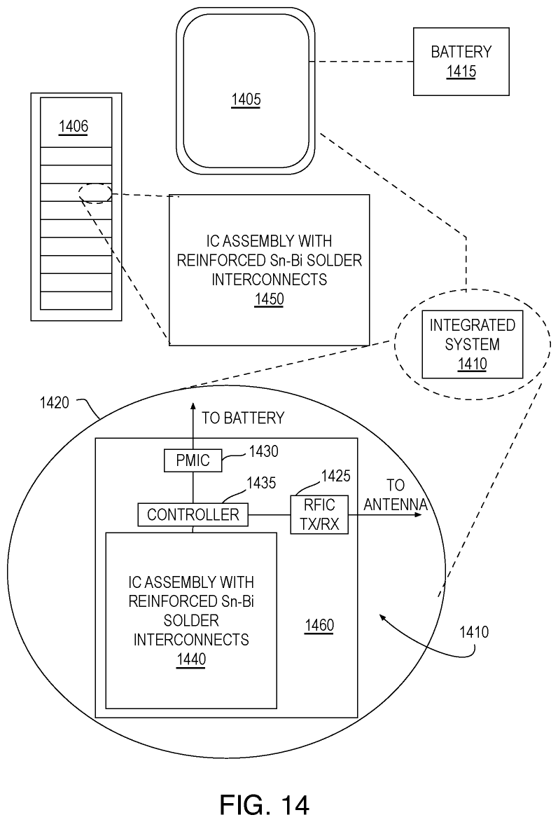

FIG. 14 illustrates exemplary systems employing an assembly including a solder interconnect having metal reinforcement particles within a tin-bismuth bulk solder material, in accordance with some embodiments. The system may be a mobile computing platform 1405 and/or a data server machine 1406, for example. Either may employ an assembly including a solder interconnect having metal reinforcement particles within a tin-bismuth bulk solder material as described elsewhere herein. Data server machine 1406 may be any commercial server, for example including any number of high-performance computing platforms disposed within a rack and networked together for electronic data processing, which in the exemplary embodiment includes an IC die assembly 1450 with an assembly including a solder interconnect having metal reinforcement particles within a tin-bismuth bulk solder material as described elsewhere herein. Mobile computing platform 1405 may be any portable device configured for each of electronic data display, electronic data processing, wireless electronic data transmission, or the like. For example, mobile computing platform 1405 may be any of a tablet, a laptop computer, etc., and may include a display screen (e.g., a capacitive, inductive, resistive, or optical touchscreen), a chip-level or package-level integrated system 1410, and a battery 1415. Although illustrated with respect to mobile computing platform 1405, in other examples, chip-level or package-level integrated system 1410 and a battery 1415 may be implemented in a desktop computing platform, an automotive computing platform, an internet of things platform, or the like. As discussed below, in some examples, the disclosed systems may include a sub-system 1460 such as a system on a chip (SOC) or an integrated system of multiple ICs, which is illustrated with respect to mobile computing platform 1405.

Whether disposed within integrated system 1410 illustrated in expanded view 1420 or as a stand-alone packaged device within data server machine 1406, sub-system 1460 may include memory circuitry and/or processor circuitry 1440 (e.g., RAM, a microprocessor, a multi-core microprocessor, graphics processor, etc.), a power management integrated circuit (PMIC) 1430, a controller 1435, and a radio frequency integrated circuit (RFIC) 1425 (e.g., including a wideband RF transmitter and/or receiver (TX/RX)). As shown, one or more IC dice, such as memory circuitry and/or processor circuitry 1440 may be assembled and implemented such that one or more are incorporated in a system having an assembly including a solder interconnect having metal reinforcement particles within a tin-bismuth bulk solder material as described herein. In some embodiments, RFIC 1425 includes a digital baseband and an analog front end module further comprising a power amplifier on a transmit path and a low noise amplifier on a receive path). Functionally, PMIC 1430 may perform battery power regulation, DC-to-DC conversion, etc., and so has an input coupled to battery 1415, and an output providing a current supply to other functional modules. As further illustrated in FIG. 14, in the exemplary embodiment, RFIC 1425 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. Memory circuitry and/or processor circuitry 1440 may provide memory functionality for sub-system 1460, high level control, data processing and the like for sub-system 1460. In alternative implementations, each of the SOC modules may be integrated onto separate ICs coupled to a package substrate, interposer, or board.

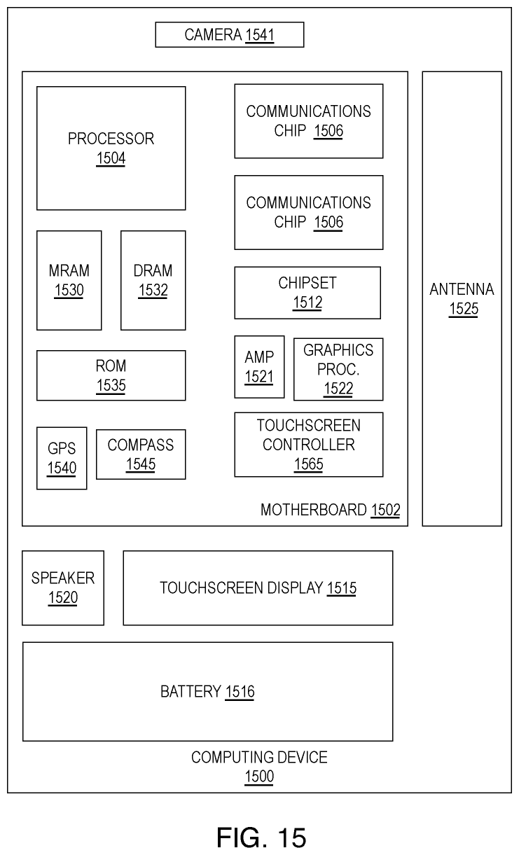

FIG. 15 is a functional block diagram of an electronic computing device 1500, in accordance with some embodiments. For example, device 1500 may, via any suitable component therein, employ an assembly including a solder interconnect having metal reinforcement particles within a tin-bismuth bulk solder material in accordance with any embodiments described elsewhere herein. For example, any component may be electrically coupled to a motherboard or package substrate 1502 via a solder interconnect having metal reinforcement particles within a tin-bismuth bulk solder material. Device 1500 further includes motherboard or package substrate 1502 hosting a number of components, such as, but not limited to, a processor 1504 (e.g., an applications processor). Processor 1504 may be physically and/or electrically coupled to motherboard or package substrate 1502. In general, the term “processor” or “microprocessor” may refer to any device or portion of a device that processes electronic data from registers and/or memory to transform that electronic data into other electronic data that may be further stored in registers and/or memory.

In various examples, one or more communication chips 1506 may also be physically and/or electrically coupled to motherboard or package substrate 1502. In further implementations, communication chips 1506 may be part of processor 1504. Depending on its applications, computing device 1500 may include other components that may or may not be physically and electrically coupled to motherboard 1502. These other components include, but are not limited to, volatile memory (e.g., DRAM 1532), non-volatile memory (e.g., ROM 1535), flash memory (e.g., NAND or NOR), magnetic memory (MRAM 1530), a graphics processor 1522, a digital signal processor, a crypto processor, a chipset 1512, an antenna 1525, touchscreen display 1515, touchscreen controller 1565, battery 1516, audio codec, video codec, power amplifier 1521, global positioning system (GPS) device 1540, compass 1545, accelerometer, gyroscope, speaker 1520, camera 1541, and mass storage device (such as hard disk drive, solid-state drive (SSD), compact disk (CD), digital versatile disk (DVD), and so forth, or the like.

Communication chips 1506 may enable wireless communications for the transfer of data to and from the computing device 1500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chips 1506 may implement any of a number of wireless standards or protocols, including, but not limited to, those described elsewhere herein. As discussed, computing device 1500 may include a plurality of communication chips 1506. For example, a first communication chip may be dedicated to shorter-range wireless communications, such as Wi-Fi and Bluetooth, and a second communication chip may be dedicated to longer-range wireless communications such as GPS, EDGE, GPRS, CDMA, WiMAX, LTE, Ev-DO, and others.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the invention is not limited to the embodiments so described, but can be practiced with modification and alteration without departing from the scope of the appended claims. For example, the above embodiments may include specific combinations of features as further provided below.

The following pertain to exemplary embodiments.

In one or more first embodiments, a solder material comprises a bulk material comprising tin and bismuth, a plurality of particles interspersed in the bulk material, wherein the plurality of particles are a metal other than tin or bismuth, and an intermetallic compound immediately adjacent one or more of the plurality of particles, the intermetallic compound comprising the metal of the plurality of particles and one of tin or bismuth.

In one or more second embodiments, further to the first embodiments, the metal of the plurality of particles is one of aluminum, scandium, titanium, vanadium, chromium, manganese, iron, cobalt, nickel, copper, zinc, gallium, germanium, rubidium, strontium, yttrium, zirconium, niobium, molybdenum, ruthenium, rhodium, palladium, silver, cadmium, indium, antimony, cesium, barium, hafnium, tantalum, tungsten, iridium, platinum, or gold.

In one or more third embodiments, further to the first or second embodiments, the plurality of particles are one of pure copper or pure nickel.

In one or more fourth embodiments, further to the first through third embodiments, the intermetallic compound comprises tin and one of copper or nickel.

In one or more fifth embodiments, further to the first through fourth embodiments, the intermetallic compound comprises one of crystalline Cu₆Sn₅ or Ni₆Sn₅.

In one or more sixth embodiments, further to the first through fifth embodiments, each of the plurality of particles has a cross-sectional width between 1 and 8 microns.

In one or more seventh embodiments, further to the first through sixth embodiments, a portion of the intermetallic compound extends from a first particle of the one or more of the plurality of particles to a second particle of the one or more of the plurality of particles.

In one or more eighth embodiments, further to the first through seventh embodiments, the bulk material comprises a eutectic compound of tin and bismuth or an off-eutectic compound of tin and bismuth.

In one or more ninth embodiments, further to the first through eighth embodiments, the solder material further comprises a plurality of second particles interspersed in the bulk material, wherein the plurality of second particles are a second metal other than tin or bismuth, and a second intermetallic compound immediately adjacent one or more of the plurality of second particles, the second intermetallic compound comprising the second metal of the plurality of second particles and one of tin or bismuth.

In one or more tenth embodiments, further to the first through ninth embodiments, the metal of the plurality of particles is copper, the second metal of the plurality of second particles is nickel, the intermetallic compound comprises tin and copper, and the second intermetallic compound comprises tin and nickel.

In one or more eleventh embodiments, further to the first through tenth embodiments, an apparatus or a system comprises a first metallization structure of a host component and a second metallization structure of an integrated circuit (IC) device coupled by an interconnect structure comprising the solder material of any of the first through tenth embodiments.

In one or more twelfth embodiments, further to the first through tenth embodiments, an apparatus or a system comprises a microelectronics board and an integrated circuit (IC) package coupled by an interconnect structure comprising the solder material of any of the first through tenth embodiments.

In one or more thirteenth embodiments, an apparatus comprises a first metallization structure of a host component, a second metallization structure of an integrated circuit (IC) device, and an interconnect structure coupling the first metallization structure and the second metallization structure, the interconnect structure comprising a bulk material comprising tin and bismuth, a plurality of pure metal particles interspersed in the bulk material, wherein the metal of the plurality of pure metal particles is other than tin or bismuth, and an intermetallic compound immediately adjacent one or more of the plurality of pure metal particles, the intermetallic compound comprising the metal of the plurality of pure metal particles and tin or bismuth.

In one or more fourteenth embodiments, further to the thirteenth embodiments, the metal of the plurality of pure metal particles is one of copper or nickel.

In one or more fifteenth embodiments, further to the thirteenth or fourteenth embodiments, the bulk material comprises a eutectic compound of tin and bismuth, and wherein the intermetallic compound comprises one of Cu₆Sn₅ or Ni₆Sn₅.

In one or more sixteenth embodiments, further to the thirteenth through fifteenth embodiments, each of the plurality of pure metal particles has a cross-sectional width between 1 and 8 microns, and a network of the intermetallic compound extends between the first metallization structure and the second metallization structure.

In one or more seventeenth embodiments, further to the thirteenth through sixteenth embodiments, the apparatus further comprises a power supply coupled to one of the host component or the IC device.

In one or more eighteenth embodiments, an apparatus comprises a first metallization structure of a host component, a second metallization structure of an integrated circuit (IC) device, and an interconnect structure coupling the first metallization structure and the second metallization structure, the interconnect structure comprising a bulk material comprising tin and bismuth, a plurality of pure metal particles interspersed in the bulk material, wherein the metal of the plurality of pure metal particles is other than tin or bismuth, and an intermetallic compound immediately adjacent one or more of the plurality of pure metal particles, the intermetallic compound comprising the metal of the plurality of pure metal particles and tin or bismuth.

In one or more nineteenth embodiments, further to the eighteenth embodiments, the metal of the plurality of pure metal particles is one of copper or nickel.

In one or more twentieth embodiments, further to the eighteenth or nineteenth embodiments, the bulk material comprises a eutectic compound of tin and bismuth, and wherein the intermetallic compound comprises one of Cu₆Sn₅ or Ni₆Sn₅.

In one or more twenty-first embodiments, further to the eighteenth through twentieth embodiments, each of the plurality of pure metal particles has a cross-sectional width between 1 and 8 microns, and wherein a network of the intermetallic compound extends between the first metallization structure and the second metallization structure.

In one or more twenty-second embodiments, further to the eighteenth through twenty-first embodiments, the apparatus further comprises a power supply coupled to one of the host component or the IC device.

However, the above embodiments are not limited in this regard and, in various implementations, the above embodiments may include the undertaking of only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

What is claimed is:

1. A solder material, comprising:
a bulk material comprising tin and bismuth;
a plurality of particles interspersed in the bulk material, wherein the plurality of particles are a metal other than tin or bismuth; and
an intermetallic compound immediately adjacent one or more of the plurality of particles, the intermetallic compound comprising the metal of the plurality of particles and one of tin or bismuth.

2. The solder material of claim 1, wherein the metal of the plurality of particles is one of aluminum, scandium, titanium, vanadium, chromium, manganese, iron, cobalt, nickel, copper, zinc, gallium, germanium, rubidium, strontium, yttrium, zirconium, niobium, molybdenum, ruthenium, rhodium, palladium, silver, cadmium, indium, antimony, cesium, barium, hafnium, tantalum, tungsten, iridium, platinum, or gold.

3. The solder material of claim 1, wherein the plurality of particles are one of pure copper or pure nickel.

4. The solder material of claim 3, wherein the intermetallic compound comprises tin and one of copper or nickel.

5. The solder material of claim 4, wherein the intermetallic compound comprises one of crystalline Cu₆Sn₅ or Ni₆Sn₅.

6. The solder material of claim 1, wherein each of the plurality of particles has a cross-sectional width between 1 and 8 microns.

7. The solder material of claim 1, wherein a portion of the intermetallic compound extends from a first particle of the one or more of the plurality of particles to a second particle of the one or more of the plurality of particles.

8. The solder material of claim 1, wherein the bulk material comprises a eutectic compound of tin and bismuth or an off-eutectic compound of tin and bismuth.

9. The solder material of claim 1, further comprising:
a plurality of second particles interspersed in the bulk material, wherein the plurality of second particles are a second metal other than tin or bismuth; and
a second intermetallic compound immediately adjacent one or more of the plurality of second particles, the second intermetallic compound comprising the second metal of the plurality of second particles and one of tin or bismuth.

10. The solder material of claim 9, wherein the metal of the plurality of particles is copper, the second metal of the plurality of second particles is nickel, the intermetallic compound comprises tin and copper, and the second intermetallic compound comprises tin and nickel.

11. An apparatus, comprising:
a first metallization structure of a host component;
a second metallization structure of an integrated circuit (IC) device; and
an interconnect structure coupling the first metallization structure and the second metallization structure, the interconnect structure comprising:
a bulk material comprising tin and bismuth;
a plurality of pure metal particles interspersed in the bulk material, wherein the metal of the plurality of pure metal particles is other than tin or bismuth; and
an intermetallic compound immediately adjacent one or more of the plurality of pure metal particles, the intermetallic compound comprising the metal of the plurality of pure metal particles and tin or bismuth.

12. The apparatus of claim 11, wherein the metal of the plurality of pure metal particles is one of copper or nickel.

13. The apparatus of claim 12, wherein the bulk material comprises a eutectic compound of tin and bismuth, and wherein the intermetallic compound comprises one of Cu₆Sn₅ or Ni₆Sn₅.

14. The apparatus of claim 11, wherein each of the plurality of pure metal particles has a cross-sectional width between 1 and 8 microns, and wherein a network of the intermetallic compound extends between the first metallization structure and the second metallization structure.

15. The apparatus of claim 11, further comprising a power supply coupled to one of the host component or the IC device.

16. An apparatus, comprising:
a microelectronics board;
an integrated circuit (IC) package comprising one or more IC devices; and
an interconnect structure electrically coupling the microelectronics board to the IC package, the interconnect structure comprising:
a bulk material comprising tin and bismuth;
a plurality of pure copper or nickel particles interspersed in the bulk material; and
an intermetallic compound immediately adjacent one or more of the plurality of pure copper or nickel particles, the intermetallic compound comprising tin and one of copper or nickel.

17. The apparatus of claim 16, wherein the intermetallic compound comprises one of crystalline Cu₆Sn₅ or Ni₆Sn₅.

18. The apparatus of claim 16, wherein each of the plurality of pure copper or nickel particles has a cross-sectional width between 1 and 8 microns, and wherein a network of the intermetallic compound extends between a first metallization structure of the microelectronics board and a second metallization structure of the IC package.

19. The apparatus of claim 16, wherein the bulk material comprises a eutectic compound of tin and bismuth or an off-eutectic compound of tin and bismuth.

20. The apparatus of claim 16, further comprising a power supply coupled to the microelectronics board.
